(19) United States
(12) Patent Application Publication
(10) Pub. No.: US 2016/0362132 A1
(43) Pub. Date: Dec. 15, 2016

(54) TIE ROD END AND METHOD FOR MANUFACTURING THEREOF

(71) Applicant: Hyundai Motor Company, Seoul (KR)

(72) Inventor: Seung Bum Cho, Seoul (KR)

(73) Assignee: Hyundai Motor Company, Seoul (KR)

(21) Appl. No.: 14/956,219

(22) Filed: Dec. 1, 2015

(30) Foreign Application Priority Data
Jun. 9, 2015 (KR) 10-2015-0080932

(51) Int. Cl. B62D 7/08; B29C 45/14; F16C 11/06

(52) U.S. Cl. CPC B62D 7/08; F16C 11/068; F16C 11/0685; B29C 45/14467; B29C 45/14754; B29L 2031/30

(57) ABSTRACT

Disclosed are a tie rod end and a method for manufacturing a tie rod end. The tie rod end includes a ball stud that has a head and a stud portion connected to one side of the head, a ball seat that surrounds the head such that the head can move within a predetermined angle range, a housing that has an internal space for receiving the head and the ball seat, and a grease pocket that is formed at a side of the internal space to be applied with a grease and is surrounded by an outer surface of the other side of the head and an inner surface of the housing.

### CROSS-REFERENCE TO RELATED APPLICATION

The present application claims priority of Korean Patent Application Number 10-2015-0080932 filed on Jun. 9, 2015, the entire contents of which are incorporated herein for all purposes by this reference.

### BACKGROUND

Technical Field

The present disclosure relates to a tie rod end and a method for manufacturing the tie rod end. More particularly, it relates to a tie rod end of an automotive steering system and a method for manufacturing the tie rod end.

Background Art

In general, an automotive steering system includes a steering wheel disposed in front of a driver's seat, a steering shaft connected to the lower portion of the steering wheel, and a gear box crossing the lower end of the steering shaft and converting rotational motion force transmitted from the steering shaft into straight motion force in the left and right of a vehicle.

The gear box has a rack bar sliding left/right therein and tie rods are coupled to both ends of the rack bar through tie rod ends.

In detail, the rack bar extends left and right in a hollow rack housing forming the external shape of the gear box and can slide axially.

Tie rods and tie rod ends are coupled to both ends of the rack bar and tire wheels for steering are coupled to the tie rod ends.

Herein, the tie rod end is disposed between the rack bar and the tie rod to axially transmit power and enable swinging and rotating.

Such tie rod ends have been disclosed in Korean Patent Application Publication No. 10-2006-0104385 and Korean Patent No. 10-1357452.

Meanwhile, FIGS. 1 to 3 are views illustrating different kinds of tie rod ends of the related art.

The tie rod end of the related art illustrated in FIG. 1, which is a bottom caulking type tie rod end, is manufactured by inserting a ball stud 114 functioning as a spheroid joint and a ball seat 113, which surrounds and protects a side of the ball stud 111 and adjusts a friction force between the ball stud 111 and a housing 112, into the housing 112, closing an opening 115 of the housing 112 with a cap 114, and fixing the edge of the cap 114 by caulking the lower end of the housing 112.

In this case, grease is applied to the inner side of the ball seat 113 and the ball seat 113 is combined with the ball stud 111 and then inserted into the housing 112.

The tie rod end of the related art illustrated in FIG. 2, which is a top caulking type (or CAP-less type) tie rod, is manufactured by inserting a ball stud 121 functioning as a spheroid joint and a ball seat 123, which surrounds a side of the ball stud 121 and adjusts a friction force between the ball stud 121 and a housing 112, into the housing 122, and then fixing the ball stud 121 in the housing 122 by caulking the top of the housing 122.

In this case also, grease is applied to the inner side of the ball seat 123 and the ball seat 123 is combined with the ball stud 121 and then inserted into the housing 122.

However, the bottom caulking type tie rod of the related art is manufactured through an easy process, but the caulking portion of the housing 112 cannot be plated/painted and gets quickly rusty and torque is largely distributed by caulking distribution.

As for the top caulking type tie rod end of the related art, the non-plated caulking portion is not exposed to the outside, so it is strong against rust, but torque is largely distributed too by caulking distribution.

The tie rod end of the related art illustrated in FIG. 3, which is an insert molding type tie rod end for improving the defects of the tie rod ends illustrated in FIGS. 1 and 2, is manufactured by inserting a ball stud 131 and a spacer 134 into a housing 132 and then insert molding a ball seat 132 in the housing 132 by injecting plastic resin for molding the ball seat 133 through an injection hole formed through the bottom of the housing 132.

In this case, it is impossible to apply grease to the inner side of the ball seat 132 due to the insert molding of the ball seat 132 and it is also impossible to apply grease to an outer side of the ball stud 131 (grease slides), so a spacer 134 having a grease pocket is additionally provided between the ball stud 131 and the bottom of the housing 132 in order to define a space to keep grease, thereby ensuring a grease pocket for keeping grease.

The insert molding type tie rod end does not undergo caulking, so there is no need for omitting plating/painting for caulking, anti-rust is strong and distribution of torque due to caulking distribution reduces. However, since the spacer 134 is added, the numbers of parts and manufacturing processes increase.

The information disclosed in this Background section is only for enhancement of understanding of the general background of the invention and should not be taken as an acknowledgement or any form of suggestion that this information forms the prior art already known to a person skilled in the art.

### SUMMARY OF THE DISCLOSURE

The present invention has been made in an effort to solve the above-described problems associated with prior art and/or other problems.

In one aspect, the present invention provides a tie rod end which has a grease pocket for keeping grease needed between a ball stud and a ball seat and of which the numbers of parts and manufacturing cost may be reduced by removing a spacer used in the related art, and a method for manufacturing the tie rod end.

In a preferred embodiment, a tie rod end includes: a ball stud that has a head and a stud portion connected to one side of the head; a ball seat that surrounds the head such that the head can move within a predetermined angle range; a housing that has an internal space for receiving the head and the ball seat; and a grease pocket that is formed at a side of the internal space to be applied with a grease and is surrounded by an outer surface of the other side of the head and an inner surface of the housing.

In an aspect, the grease pocket is a closed space surrounded by the outer surface of the other side of the head, which is opposite to the side of the head where the stud portion is connected to, and the inner surface of the housing, and a spherical inner surface of the housing surrounding a bottom of the grease pocket has a curvature the same as that of a spherical portion of the head.

The internal space of the housing includes a resin space where injection resin for molding the ball seat is injected and the grease pocket where the grease is applied, wherein a height difference exists between a bottom of the resin space and a top of the grease pocket to prevent the resin from flowing into the grease pocket.

In another preferred embodiment, a non-spherical portion is formed at the other side of the head opposite to the side where the stud portion is connected to, and the grease pocket is a closed space surrounded by the non-spherical portion of the head inserted in the housing and the inner surface of the housing.

In still another preferred embodiment, the ball seat is molded between the housing and the head by injecting resin into the internal space of the housing with the head inserted therein and the housing has a resin injection hole for injecting resin to mold the ball seat.

In another aspect, the present invention provides a method for manufacturing a tie rod end. The method includes: forming a housing having an internal space including a grease pocket; applying a grease to the grease pocket; inserting a head of a ball stud into the internal space of the housing, wherein the ball stud further includes a stud portion connected to one side of the head, such that an outer surface of the other side of the head surrounds the grease pocket in cooperation with an inner surface of the housing; and molding a ball seat between the housing and the head by injecting resin into the internal space of the housing, wherein the ball seat surrounds the head and the head is movable.

According to the tie rod end and the method for manufacturing the tie rod end, since it is possible to directly machine and secure a grease pocket at a side of a housing, there is no need for a spacer used in the related art, so the number of parts decreases and the manufacturing cost/weight and a package are reduced. Further, since there is no need for a process of inserting a spacer, the manufacturing process reduces and the rate of problems with quality may be reduced.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (for example, fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a view illustrating a bottom caulking type tie rod end according to the related art;

FIG. 2 is a view illustrating a top caulking type tie rod end according to the related art;

FIG. 3 is a view illustrating an insert molding type tie rod end according to the related art;

FIG. 4 is a view illustrating a tie rod end according to an embodiment of the present invention;

FIG. 5 is a view illustrating a housing of the tie rod end according to an embodiment of the present invention; and

FIG. 6 is a view illustrating a method for manufacturing a tie rod end according to an embodiment of the present invention.

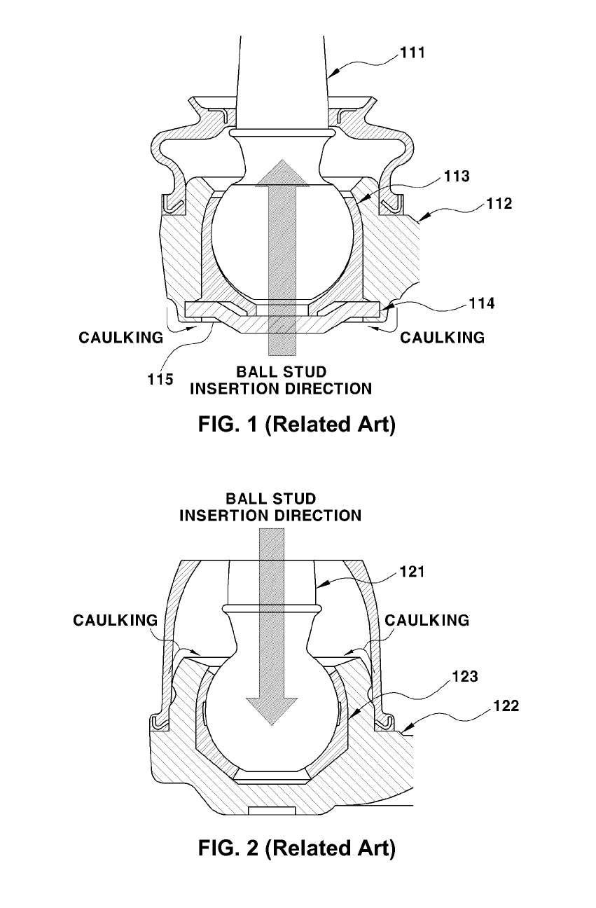

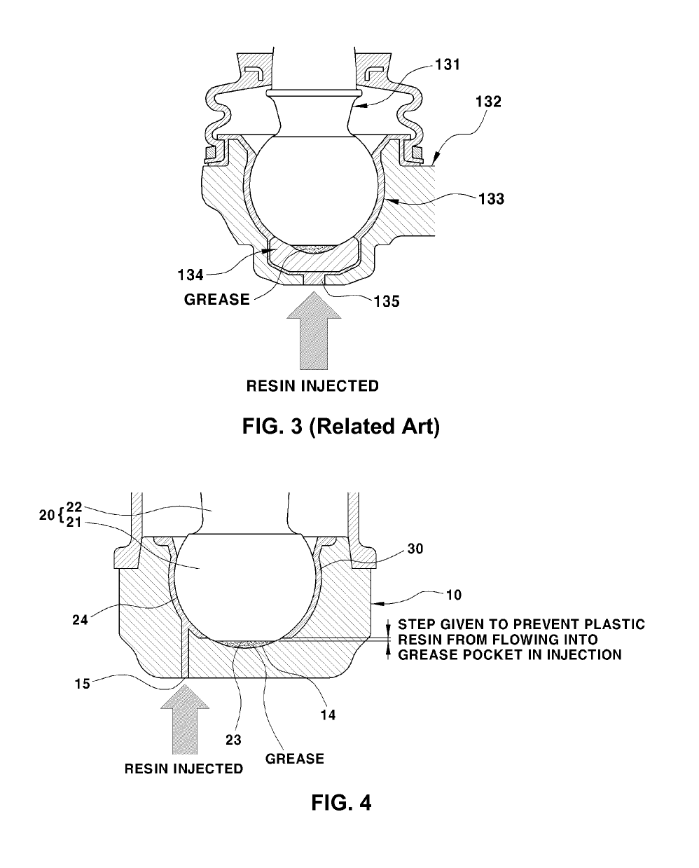

Reference numerals set forth in the Drawings includes reference to the following elements as further discussed below:

| | |
|---|---|
| 10: housing | 11: internal space |
| 12: head space | 13: resin space |
| 14: grease injection hole | 15: resin injection hole |
| 16: opening | 20: ball stud |
| 21: head | 22: stud portion |
| 23: non-spherical portion | 24: spherical portion |
| 30: ball seat | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

As illustrated in FIG. 4, a tie rod end according to the present invention includes a housing 10, and a ball stud 20 and a ball seat 30 inserted in the housing 10.

The ball stud 20 is composed of a spherical head 21 functioning as a spheroid joint and a bar-shaped stud portion 22 at a side of the head 21. The head 21 has a non-spherical portion 23 on the outer side of the other side opposite to the side where the stud portion 22 is integrally connected or monolithically formed.

The non-spherical portion 23 may be machined in a flat shape and the contact area with the ball seat 30 depends on the size of the non-spherical portion 23, so it is possible to adjust torque by contact with the ball seat 30 by appropriately adjusting the area of the non-spherical portion 23.

The ball seat 30 is molded and inserted in the housing 10 by molding or injection molding, surrounds the other portion of the outer side of the head 21 except for the non-spherical portion 23 (e.g., most part of the spherical portion 24), and has a spherical inner side so that the ball stud 20 can freely rotate within a predetermined angle (operation angle) range therein.

The ball seat 30 surrounds and protects the head 21, adjusts a friction force between the head 21 and the housing 10, and is molded between the housing 10 and the head 21 by injection resin injected into the housing 10.

To this end, a resin injection hole 15 for injecting injection resin for molding the ball seat 30 is formed at the opposite side to the opening 16 in the housing 10.

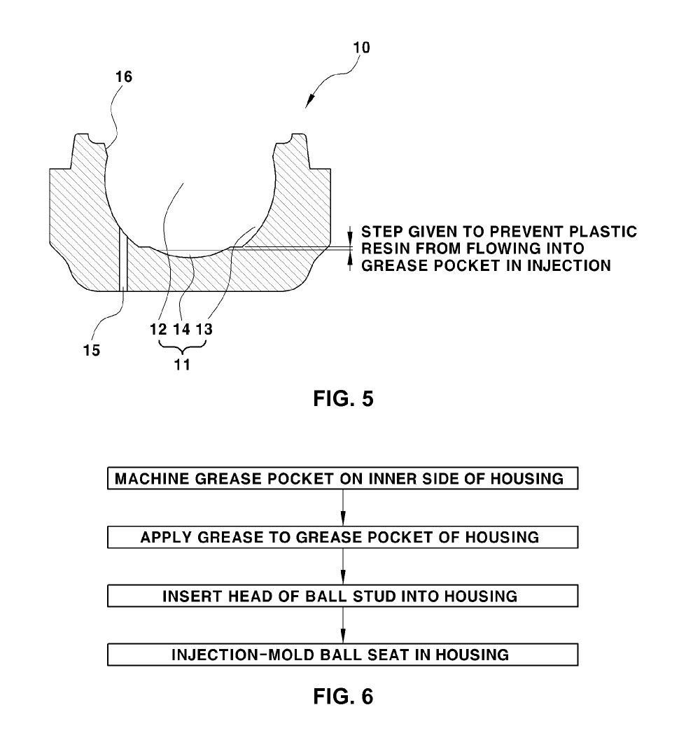

As illustrated in FIG. 5, the housing 10 has an internal space 11 where the head 21 and the ball seat 30 are inserted and the internal space 11 has a substantially spherical shape with a side open.

In detail, the internal space 11 has a head space 12 at the center where the head 21 is inserted, a resin space 13 where the ball seat 30 is molded and disposed around the outside, and a grease pocket 14 where grease for lubrication between the ball seat 30 and the head 21 is applied and filled, at the lower portion.

The head space 12 and the grease pocket 14 define a spherical space and the resin space 13 is defined around the outer side of the head space 12, thereby defining a space substantially corresponding to the ball seat 30.

The grease pocket 14 is formed by machining a portion of the inner side of the housing 10 which faces the non-spherical portion 23 of the head 21, in detail, between the non-spherical portion 23 of the head 21 inserted in the internal space 11 of the housing 10 and the portion opposite to the opening 16 of the inner side of the housing 10.

When the head 21 is inserted in the internal space 11 of the housing 10, the non-spherical portion 23 of the head 21 is placed over the grease pocket 14 and the top of the grease pocket 14 is surrounded by the non-spherical portion 23, so a closed spaces is defined by the non-spherical portion 23 of the head 21 and the inner side of the spherical surface (curved surface) of the housing 10.

Herein, a portion of the inner side of the housing 10 surrounding the bottom of the grease pocket 14 is machined in a spherical shape having a curvature the same as that of the spherical portion 24 of the head 21, and as illustrated in FIG. 4, and forms a sphere having a predetermined curvature in cooperation with the spherical portion 24 of the head 21 placed over the grease pocket 14.

When injection resin (e.g., plastic resin) for molding the ball seat 30 is inserted into the housing 10, in order to prevent the plastic resin from flowing into the grease pocket 14, a step having a height difference is formed between the top of the grease pocket 14 and the bottom of the resin space 13 in the housing 10.

Herein, a method for manufacturing a tie rod end according to some embodiments of the present invention is described hereafter with reference to FIG. 6.

First, a housing 10 having an internal space 11 open at a side is formed as a housing of a tie rod end.

In this case, the internal space 11 includes a head space 12, a resin space 13, and a grease pocket 14 and it is possible to secure a spherical surface (curved surface) corresponding to the outer side the a ball seat 30 by machining the inner side of the housing 10 close to the inner space 11 and a spherical surface (curved surface) making (or surrounding) a side (the bottom) of a grease pocket 14.

Next, grease for lubrication between the ball seat 30 and the head 21 is applied and filled in the grease pocket 14.

Next, the head 21 of a prepared ball stud 20 is inserted into the internal space 11 of the housing 10 to be placed over the grease pocket 14 in the head space 12 and the ball seat 30 surrounding the head 21 such that the head can move is injection-molded between the housing 10 and the head 21 by injecting injection resin for molding the ball seat 30 in the internal space 11.

In this case, the ball stud 20 and the housing 10 are fixed at a predetermined position on a mold for insert molding of the ball seat 30 such that the housing 10 and the ball stud 20 are not moved, and then the ball seat 30 is molded by injecting injection resin into the resin space 13 in the internal space 11 through a resin injection hole 15 in the housing 10.

Herein, as the head 21 is inserted into the internal space 11 of the housing 10 to be placed over the grease pocket 14, the outer side (that is, a non-spherical portion) at the other side of the head 21 opposite to a stud portion 22 surrounds and closes the grease pocket 14 in cooperation with the inner side of the housing 10.

For convenience in explanation and accurate definition in the appended claims, the terms “inner” or “outer”, “left” or “right”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments.

What is claimed is:

1. A tie rod end comprising:
a ball stud that has a head and a stud portion connected to one side of the head;
a ball seat that surrounds the head such that the head can move within a predetermined angle range;
a housing that has an internal space for receiving the head and the ball seat; and
a grease pocket that is formed at a side of the internal space to be applied with a grease and is surrounded by an outer surface of the other side of the head and an inner surface of the housing.

2. The tie rod end of claim 1, wherein the grease pocket is a closed space surrounded by the outer surface of the other side of the head which is opposite to the side of the head where the stud portion is connected to, and the inner surface of the housing.

3. The tie rod end of claim 1, wherein the internal space of the housing includes a resin space where injection resin for molding the ball seat is injected and the grease pocket where the grease is applied, wherein a height difference exists between a bottom of the resin space and a top of the grease pocket.

4. The tie rod end of claim 1, wherein a non-spherical portion is formed at the other side of the head opposite to the side where the stud portion is connected to, and the grease pocket is a closed space surrounded by the non-spherical portion of the head inserted in the housing and the inner surface of the housing.

5. The tie rod end of claim 1, wherein a spherical inner surface of the housing surrounding a bottom of the grease pocket has a curvature the same as that of a spherical portion of the head.

6. The tie rod end of claim 1, wherein the ball seat is molded between the housing and the head by injecting resin into the internal space of the housing with the head inserted therein.

7. The tie rod end of claim 1, wherein the housing has a resin injection hole for injecting resin to mold the ball seat.

8. A method for manufacturing a tie rod end, comprising:
forming a housing having an internal space including a grease pocket;
applying a grease to the grease pocket;
inserting a head of a ball stud into the internal space of the housing, wherein the ball stud further includes a stud portion connected to one side of the head, such that an outer surface of the other side of the head surrounds the grease pocket in cooperation with an inner surface of the housing; and
molding a ball seat between the housing and the head by injecting resin into the internal space of the housing, wherein the ball seat surrounds the head and the head is movable.

9. The method of claim 8, wherein the internal space of the housing includes a resin space where the resin for molding the ball seat is injected and the grease pocket where the grease is applied, wherein a height difference exists between a bottom of the resin space and a top of the grease pocket.

10. The method of claim 8, wherein in molding the ball seat, the resin is injected into the internal space of the housing through a resin injection hole formed at a side of the housing.
